(19) United States
(12) Patent Application Publication
(10) Pub. No.: US 2004/0024506 A1
(43) Pub. Date: Feb. 5, 2004

(54) Vehicle steering system with visual feedback display

(76) Inventor: Michael J. Augustine, Mayville, MI (US)

Correspondence Address: KEITH J. MURPHY, CANTOR COLBURN LLP, 55 Griffin Road South, Bloomfield, CT, 06002, US

(21) Appl. No.: 10/210,822

(22) Filed: Aug. 1, 2002

(51) Int. Cl. B62D 5/04

(52) U.S. Cl. 701/41; 180/443

(57) ABSTRACT

A steering system for a vehicle is provided. The steering system comprises a steering input device, a steering output device, a display unit, and a position control system. The position control system controls the position of the steering output device based upon an input from the steering input device. The display unit provides visual feedback of the position of the steering output device to an operator.

### TECHNICAL FIELD

This disclosure relates generally to steering systems. More specifically, this disclosure relates to steering systems having a visual feedback display.

### BACKGROUND

Vehicles require a steering system to control the direction of travel. Previously, mechanical steering systems have been used. Mechanical steering systems typically include a mechanical linkage or a mechanical connection between a steering input device and a steering output device. Thus, movement of the steering input device causes a corresponding movement of the steering output device. The movement of the steering output device by the steering input device is often power assisted by a hydraulic actuator or an electric motor.

Mechanical steering systems are being replaced and/or supplemented by electrically driven steering systems. Such systems replace, to varying extents, the mechanical linkage between the steering input device and the steering output device with, for example, an electrically assisted system. Examples of such systems include steer-by-wire systems, four wheel steering systems, and others.

These systems mechanically isolate the steering input device from the steering output device, which can eliminate certain desired feedback. For example, due to the mechanical isolation between the steering input and output devices, the devices may be manipulated independent of one another when the vehicle is non-operational. If either or both of the devices are manipulated when the vehicle is non-operational, then the input and output devices may be out of synchronization with each other upon start up of the vehicle (e.g., an offset can be introduced).

In current steering systems, the operator uses the visual appearance of the steering input device itself as a reference to indicate the position of the steering output device. This point is illustrated by way of example with reference to an automobile having a steering wheel as the input device and steerable road wheels as the output device. In this example, the steering wheel has one or more visual references useable by the operator to detect the relative position of the steering wheel. Some examples of visual references useable by the operator to detect the relative position of the steering wheel include the manufacture's logo, indications noting a supplemental restraint system (e.g., an airbag), or even the biased “spokes” of the steering wheel itself.

The operator may not be aware that an offset was induced when the system was not in use. In this instance, the operator may assume that the visual references as to the relative position of the standard steering wheel are representative of the relative position of the road wheels. If an offset was induced, the operator could misdirect the vehicle based on their incorrect assumption of the direction of the road wheels based on the position of the steering wheel. The difficulty for the operator to accurately assess the vehicle steering system direction with the vehicle stopped increases when the steering input device is a stationery hub type, joystick control, or other non-traditional steering input device.

Accordingly, it is desired to provide a steering system that provides a constant, direct, and unambiguous visual indication of the current steering system position to the operator.

### SUMMARY

A steering system for a vehicle is provided. The steering system comprises a steering input device, a steering output device, a display unit, and a position control system. The position control system controls the position of the steering output device based upon an input from one or more of the steering input device and a vehicle state sensor. The display unit provides visual feedback of the position of the steering output device to an operator.

A method of controlling a vehicle steering system display is provided. The method comprises initiating a control algorithm residing in a control unit by providing electric power to the control unit; communicating a current position of a steering output device to the control algorithm, the control algorithm providing a signal indicative of the current position to the display unit; and displaying a visual indicator of the signal on the display unit.

A steer-by-wire system for a vehicle is provided. The system comprises a steering input device, a first position sensor, a steering output device, a second position sensor, and a control unit. The first position sensor generates a first signal indicative of a position of the steering input device. The second position sensor generates a second signal indicative of a position of the steering output device. The control unit controls the position of the steering output device based upon the first and second signals. Namely, the control unit provides a third signal to an actuator, which moves the steering output device in response to the third signal. The control unit also provides a forth signal, which is indicative of the position of the steering output device, to a display unit for displaying the position of the steering output device to an operator.

The above-described and other features are appreciated and understood by those skilled in the art from the following detailed description, drawings, and appended claims.

### DESCRIPTION OF THE DRAWINGS

FIG. 1 is a schematic depiction of an exemplary embodiment of a steering system;

FIG. 2 is a block diagram of an exemplary embodiment of a control algorithm for use with a steering system; and

FIGS. 3-8 are views of alternate exemplary embodiments of display units.

### DETAILED DESCRIPTION

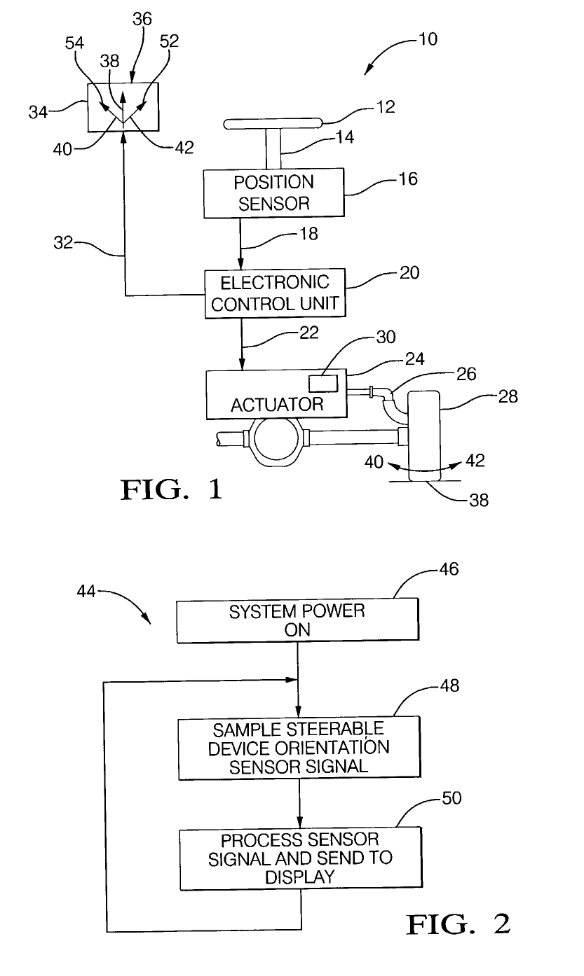

Referring now to FIG. 1, an exemplary embodiment of a steering system 10 for a vehicle (not shown) is illustrated. For purposes of clarity, the steering system 10 is described as a steer-by-wire system in use in an automobile. Of course, the use of steering systems other than steer-by-wire systems and/or the use of the steering system with other types of vehicles are contemplated.

The steer-by-wire system 10 receives operator input from a steering input device 12, such as a steering wheel. The steering input device 12 is positioned on an upper shaft 14 such that the operator can input changes to the position of the steering input device. A first position sensor 16 detects the position of the steering input device 12 and/or the upper shaft 14.

The first position sensor 16 is in electrical communication with an electronic control unit 20 by way of a first signal 18. The control unit 20 includes a microprocessor and other assorted electronic components well known in the field of electronic control for providing memory, input/output, and processing functions. The control unit 20 is in electrical communication with a road wheel actuator 24 by way of a second signal 22.

Based on the first signals 18, the control unit 20 determines what second signals 22, if any, to send to the road wheel actuator 24. The road wheel actuator 24 is, for example, an electric motor. The actuator 24 is configured to control the position of a steering output device 28, such as a set of road wheels (only one shown), by means of a tie-rod 26. Thus, the electronic control unit 20 is configured to adjust the position of the steering output device 28 to correspond with the position of the steering input device 12.

The steer-by-wire system 10 can be an active steering system, which includes vehicle state sensors (not shown). In active steering systems, the control unit 20 can determine the second signals 22 not only based upon the inputs from steering input device, but also based upon inputs from the vehicle state sensors. Here, the control unit 20 can determine the second signals 22 from the steering input device, from the vehicle state sensors, or both. For example, the vehicle state sensors can be configured to detect a yaw force on the vehicle. As used herein, yaw force is the force of the movement of the vehicle about a vertical axis of the vehicle. Yaw forces above the predetermined limit can be an indication of an adverse vehicle condition (e.g., a spin condition). If the yaw force is above a selected limit, then the controller 20 can determine what second signals 22 to send to the road wheel actuator 24 based upon the inputs from the vehicle state sensors, the steering input device, and combinations thereof.

It should be recognized that the steer-by-wire-system 10 is described herein by way of example only with respect to an exemplary type of steering input device (e.g., a steering wheel) and an exemplary type of steering output device (e.g., steerable road wheels). Of course, the steer-by-wire-system 10 of the present disclosure can be used with other steering input or output devices. Steering output devices can include devices, such as, but not limited to, the skis of a snowmobile, the nozzles or jets of a jet ski, the propellers of a boat, the wheels of a motor cycle, and the like. Steering input devices can include devices, such as, but not limited to, handlebars, joystick controls, track type input devices, and the like.

The steer-by-wire system 10 further comprises a second position sensor 30. The second position sensor 30 is configured to detect the position of the steering output device 28. In the illustrated embodiment, the second position sensor 30 detects the position of the steering output device 28 via the actuator 24. Here, the second position sensor 30 is also in electrical communication with the control unit 20 by way of the second signals 22. The control unit 20 communicates with a display unit 34 by way of a third signal 32 to provide a visual indication of the position of the steering output device 28 to the operator. Of course, it should be recognized that the second position sensor 30 could be located in other points in the system 10 to provide the position of the steering output device 28 to the control unit 20.

When the system 10 is not in use, an offset between the relative positions of the steering input device 12 and the steering output device 28 could be introduced. Namely, the system 10 does not include a locking mechanism to prevent such an offset from being introduced.

Rather, the steering input device 12 may be configured to mitigate the references useable by the operator to discern relative orientation of the steering output device 28. For example, the steering input device 12 is a solid disk-type wheel or joystick. Thus, the steering input device 12 mitigates the ability of an operator to discern the orientation of the output device merely by looking at the input device.

Since the operator's ability to discern the orientation of the output device 28 from the input device 12 has been mitigated, the display unit 34 supplies a convenient and easy to use means for discerning the orientation. In this manner, the display unit 34 functions much like the speedometer in current vehicles where the most convenient and accurate means for the operator to determine the speed of the vehicle is to reference the speedometer. In the same way, the display unit 34 provides the most convenient and accurate means for the operator to discern the position of the steering output device 28. In sum, the display unit 34 informs the operator about the position of the steering output device 28 without the need to refer to the steering input device 12.

The display unit 34 may be analog or digital, or any other form of visual feedback. The display 34 provides a visual indicator 36 of the current direction of the steering output device 28 and can display the position of the steering output device 28 in any convenient scale. For example, the visual indicator 36 can display the position of the steering output device 28 by indicating the actual degrees of movement of the steering output device from the center position, the percentage of full travel of the steering output device, the percentage of the vehicle's total steering radius currently in use, and the like.

Additionally, the visual indicator 36 can take many forms. These can include, but are not limited to, a graphical depiction of the actual position of the steering output device 28, indicator lights or gauges that provide proportional and sensual reference to the position of the output device, or text-type displays. The display unit 34 continuously updates the information provided by the indicator to reflect the current position of the steering output device 28.

The display unit 34 can be provided to the operator from various locations with in the vehicle. For example, the display unit 34 can be located on the vehicle's instrument panel. Alternately, the display unit 34 can be projected onto the windshield of the vehicle, a feature commonly known as a heads up display. The display unit 34 can be located on the steering input device 12. In this example, the display unit 34 would be configured to remain stationary as the steering input device 12 is rotated. Of course, other locations and positions of the display unit 34 are contemplated.

In the embodiment illustrated in FIG. 1, the display unit 34 is an analog gauge and the visual indicator 36 is a movable arrow. For purposes of illustration, the center position of both the steering output device 28 and the visual indicator 36 are illustrated at point 38, the leftmost position is illustrated at point 40, and the rightmost position is illustrated at point 42.

The indicator 36 comprises both a magnitude component 52 and a direction component 54. Here, the magnitude component 52 is represented by, for example, the distance the indicator 36 moves from the center position 38. The direction component 54 is represented by, for example, the direction the indicator 36 moves with respect to the center position 38. Thus, the display unit 34 provides the operator with a sense of the direction of travel of the vehicle without having to move the vehicle. Accordingly, the display 34 may be particularly advantageous in parking scenarios. Namely, the display 34 gives the operator a sense of the vehicle's direction without having to move the vehicle to prevent encroachment on objects near the vehicle.

Referring now to FIG. 2, a control algorithm 44 for use with the steer-by-wire system 10 is illustrated. The algorithm 44 resides, for example, in the control unit 20. The algorithm 44 is initiated at a first node 46, namely once power is provided to the control unit 20. The algorithm 44 detects at a second node 48 the current position of the steering output device 28. Specifically, the second node 48 receives the signals 22 indicative of the position of the steering output device 28 from the second position sensor 30.

The algorithm 44 processes the signals 22 at a third node 50. Here, the third node 50 instructs the control unit 20 to communicate the position of the steering output device 28 to the display unit 34 by way of the third signals 32. Thus, the visual indicator 36 of the position of the steering output device 28 is provided to the operator. The algorithm 44 repeats nodes 48 and 50 to continuously update the display 34 to the current position of the steering output device 28.

Thus, the control algorithm 44 does not take into account the movements of the steering input device 12 before start-up (e.g., node 46). Rather, the algorithm 44 informs the operator about the current position of the steering output device 28 via the display unit 34.

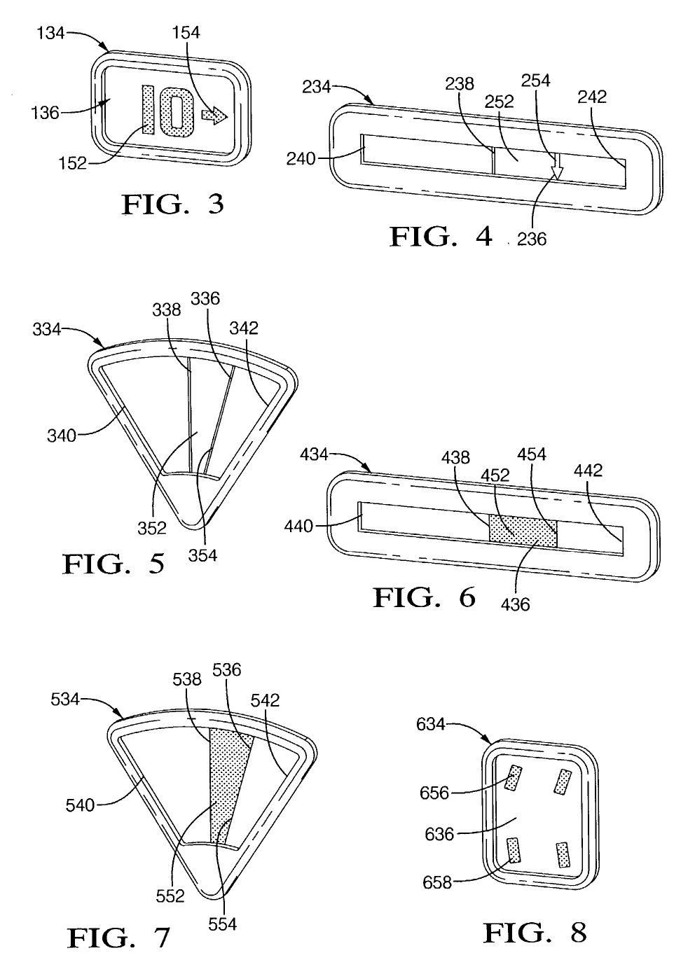

Referring now to FIGS. 3-8, alternate exemplary embodiments of the display unit are illustrated. Here, component parts performing similar or analogous functions are numbered in multiples of one hundred.

In FIG. 3, the display 134 is a digital display and the indicator 136 is a numerical display. The indicator 136 comprises both a magnitude component 152 and a direction component 154. The magnitude component 152 is a number that represents, for example the actual degrees of movement of the steering output device from the center position, the percentage of full travel, the percentage of the vehicle's total steering radius, and the like. In this embodiment, the magnitude component 152 is equal to “zero” when the steering output device is at its center position.

The direction component 154 provides an indication of the direction of the magnitude component 152. In the illustrated embodiment, the direction component 154 is an arrow. Of course, other direction components 154 such as, but not limited to, a letter to indicate left or right (e.g., an “L” and an “R”), a letter to indicate port or starboard (e.g., a “P” and an “S”), a plus or minus sign, and the like are contemplated.

Referring to FIG. 4, the display unit 234 is a linear digital display and the visual indicator 236 is a movable symbol. For purposes of illustration, the center position of the steering output device and the visual indicator 236 are illustrated at point 238, the leftmost position is illustrated at point 240, and the rightmost position is illustrated at point 242. Here, the indicator 236 moves linearly with respect to the center position 238 in the respective direction of the direction of travel of the steering output device. The amount of movement from the center position 238 is indicative of the magnitude component 252, while the direction of movement with respect to the center position is indicative of the direction component 254.

In the embodiment illustrated in FIG. 5, the display unit 334 is an angular digital display and the visual indicator 336 is a movable symbol. Again, the center position is at point 338, the leftmost position at point 340, and the rightmost position point 342. The indicator 336 moves radially with respect to the center position 338 in the respective direction of the direction of travel of the steering output device. The amount of movement from the center position 338 is indicative of the magnitude component 352, while the direction of movement with respect to the center position is indicative of the direction component 354.

Another alternate embodiment of the display unit is illustrated in FIG. 6. Here, the display unit 434 is a linear digital display and the visual indicator 436 is an expanding bar. Again, the center position is at point 438, the leftmost position is at point 440, and the rightmost position is at point 442. The indicator 436 expands linearly with respect to the center position 438 in the respective direction of the direction of travel of the steering output device. The amount of movement from the center position 438 is indicative of the magnitude component 452, while the direction of movement with respect to the center position is indicative of the direction component 454.

In the embodiment illustrated in FIG. 7, the display unit 534 is an angular digital display and the visual indicator 536 is an expanding symbol. The indicator 536 expands radially with respect to the center position 538 in the respective direction of the direction of travel of the steering output device. Again, the amount of movement from the center position 538 is indicative of the magnitude component 552, while the direction of movement with respect to the center position is indicative of the direction component 554.

Turning now to FIG. 8, the display unit 634 provides a graphical representation of each of the steering output devices. Here, the graphical representation provides a front representation 656 and a rear representation 658. The representations 656 and 658 move in accordance with the actual position of the front and rear steering output devices, respectively. It should be recognized that the display unit 634 is illustrated by way of example only for use with a four-wheel steering system. Of course, the use of the graphical representation with only a two wheel steering system is contemplated.

It should also be recognized that the display may also find use in steer-by-wire systems where the steering input device does provide visual indications of position. Further, the display may find use in steer-by-wire systems where the steering input device and steering output device are either prevented from being offset when the vehicle is not in use, or re-synchronized during the start-up. In these applications, the display provides a redundant or back-up system to indicate the position of the steering output device to the operator.

It should also be noted that the terms “first”, “second”, and “third” may be used herein to modify elements performing similar and/or analogous functions. These modifiers do not imply a spatial, sequential, or hierarchical order to the modified elements, unless otherwise indicated.

While the invention has been described with reference to one or more an exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A steering system for a vehicle, comprising:
a steering input device;
a steering output device;
means for controlling a position of said steering output device based upon an input from said steering input device; and
a display unit for providing visual feedback of said position of said steering output device to an operator.

2. The steering system as in claim 1, wherein said steering input device is configured to mitigate references useable by said operator to discern said position of said steering output device.

3. The steering system as in claim 1, wherein said visual feedback is redundant to references on said steering input device useable by said operator to discern said position of said steering output device.

4. The steering system as in claim 3, wherein said steering input device is configured to mitigate said references.

5. The steering system as in claim 1, wherein said steering system is steer-by-wire system.

6. The steering system as in claim 1, wherein said means for controlling is based upon one or more of said input from said steering input device, a vehicle condition sensor, and combinations thereof.

7. The steering system as in claim 1, wherein said means for controlling comprises:
a control unit;
a first position sensor being configured to detect said input from said steering input device and to provide said input to said controller;
a second position sensor being configured to detect said position of said steering output device and to provide said position to said controller; and
an actuator configured to move said steering output device, wherein said control unit activates said actuator to move said steering output device based upon said inputs.

8. The steering system as in claim 1, wherein said display unit comprises a visual indicator configured to display said position.

9. The steering system as in claim 7, wherein said visual indicator is an actual degrees of movement of said steering output device from a center position, a percentage of full travel of said steering output device from said center position, or a percentage of a total steering radius.

10. A method of controlling a vehicle steering system display unit, comprising:
initiating a control algorithm residing in a control unit;
communicating a current position of a steering output device to said control algorithm, said control algorithm providing a signal indicative of said current position to the display unit; and
displaying a visual indicator of said signal on the display unit.

11. The method as in claim 10, wherein said visual indicator is continuously updated by said control algorithm.

12. The method as in claim 10, wherein said visual indicator is independent of a current position of a steering input device.

13. The method as in claim 12, wherein said control unit is configured to adjust said current position of said steering output device based upon said current position of said steering input device, a vehicle state sensor signal input, and combinations thereof.

14. The method as in claim 12; further comprising:
mitigating references on said steering input device useable to discern relative orientation of said steering output device without reference to said visual indicator.

15. A steer-by-wire system for a vehicle, comprising:
a steering input device;
a first position sensor being configured to generate a first signal indicative of a position of said steering input device;
a steering output device;
a second position sensor being configured to generate a second signal indicative of a position of said steering output device; and
a control unit for controlling said position of said steering output device, said control unit providing a third signal to an actuator and a fourth signal to a display unit, said actuator moving said steering output device in response to said third signal, said display unit displaying said position of said steering output device based upon said forth signal.

16. The steer-by-wire system as in claim 15, further comprising vehicle condition sensors for providing a fifth signal indicative of a vehicle condition, said actuator moving said steering output device in response to said third signal, said fifth signal, or combinations thereof.

17. The steer-by-wire system as in claim 15, wherein said display unit is locatable within the vehicle in a location selected from the group consisting of an instrument panel, said steering input device, and a windshield.

18. The steer-by-wire system as in claim 15, where said display unit displays a visual indicator of said position of said steering output device, said visual indicator providing visual feedback of said position to an operator.

19. The steer-by-wire system as in claim 18, wherein said visual indicator comprises:
a magnitude component and a direction component, said magnitude component being indicative of a relative distance of said position from a center point, and said direction component being an indication of a direction of said magnitude component from said center position.

20. The steer-by-wire system as in claim 18, wherein said visual indicator comprises a graphical representation of said steering output device.
